(19) United States
(12) Patent Application Publication
(10) Pub. No.: US 2024/0253134 A1
(43) Pub. Date: Aug. 1, 2024

(54) MIRROR MILLING MACHINING EQUIPMENT AND METHOD FOR LARGE-SCALE ROTARY SPHERICAL THIN-WALLED PARTS

(71) Applicant: TSINGHUA UNIVERSITY, Beijing (CN)

(72) Inventors: Zenghui XIE, Beijing (CN); Fugui XIE, Beijing (CN); Xinjun LIU, Beijing (CN); Jie WEN, Beijing (CN)

(21) Appl. No.: 18/629,958

(22) Filed: Apr. 9, 2024

Related U.S. Application Data
(63) Continuation of application No. PCT/CN2022/144330, filed on Dec. 30, 2022.

(30) Foreign Application Priority Data
May 27, 2022 (CN) 202210592340.2

(51) Int. Cl. B23C 3/16

(52) U.S. Cl. CPC B23C 3/16

(57) ABSTRACT

Provided are a mirror milling machining equipment and a method for large-scale rotary spherical thin-walled parts. The equipment includes an annular base (100), an annular rotary table (200), a machining positioning assembly (300), a machining device (400), a support positioning assembly (500), and a support member (600).

### CROSS-REFERENCE TO RELATED APPLICATIONS

This application is a continuation of International Application No. PCT/CN2022/144330 filed on Dec. 30, 2022, which is submitted based on and claims a priority to Chinese Patent Application No. 202210592340.2 filed on May 27, 2022, the entire contents of which are incorporated herein by reference.

### FIELD

The present disclosure relates to the field of machining technologies for large-scale spacecraft parts, and more particularly, to a mirror milling machining equipment for large-scale rotary spherical thin-walled parts and a corresponding control method for the mirror milling machining equipment for large-scale rotary spherical thin-walled parts.

### BACKGROUND

The high-value manufacturing industry represented by aviation and aerospace embodies national manufacturing level. Large-scale rotary spherical thin-walled parts are end covers or bottom covers of launch vehicles' fuel storage tanks. This kind of parts has characteristics of large size, low rigidity, complex feature profile machining, which pose serious challenges to performance of basic machining devices in terms of operational complexity, quality consistency, machining efficiency, and precision, etc.

In the related art, a large-scale special machine tool is used for machining of large-scale rotary spherical thin-walled parts, and thus resource conflicts occur from time to time, which seriously affect the development progress of the novel launch vehicle development tasks. In addition, since such parts have a thin-walled feature, the workpiece is easy to deform during machining. Therefore, machining precision is difficult to ensure.

### SUMMARY

The present disclosure aims to solve at least one of the technical problems in the related art. To this end, the present disclosure provides a mirror milling machining equipment for large-scale rotary spherical thin-walled parts, which has advantages such as strong adaptability, high operational flexibility, and high machining precision.

The present disclosure further provides a corresponding control method for the mirror milling machining equipment for large-scale rotary spherical thin-walled parts.

To achieve the above objectives, according to an embodiment in a first aspect of the present disclosure, a mirror milling machining equipment for large-scale rotary spherical thin-walled parts is provided. The mirror milling machining equipment for large-scale rotary spherical thin-walled parts includes: an annular base; an annular rotary table rotatably disposed at the annular base, the annular rotary table being adapted for placement of a to-be-machined part and adapted to drive the to-be-machined part to rotate together; a machining positioning assembly including a machining base, a machining radial movable platform, a machining pivotal movable platform, a machining oblique movable platform, and a machining parallel positioner, the machining base being disposed at a radial outer side of the annular rotary table and provided with a machining radial track positioned in a radial direction of the annular rotary table, the machining radial movable platform being slidably disposed at the machining radial track, the machining pivotal movable platform being pivotally disposed at the machining radial movable platform and having a rotation axis perpendicular to the radial direction of the annular rotary table, the machining pivotal movable platform being provided with a machining oblique track extending, in the radial direction of the annular rotary table, obliquely upwards from outside to inside, the machining oblique movable platform being slidably disposed at the machining oblique track, and the machining parallel positioner being mounted at the machining oblique movable platform; a machining device mounted at the machining parallel positioner; a support positioning assembly including a support base, a support oblique movable platform, and a support parallel positioner, the support base being disposed at a radial inner side of the annular rotary table and provided with a support oblique track, the support oblique track extending, in the radial direction of the annular rotary table, obliquely upwards from outside to inside, the support oblique movable platform being slidably disposed at the support oblique track, and the support parallel positioner being mounted at a support oblique movable platform; and a support member mounted at the support parallel positioner.

The mirror milling machining equipment for large-scale rotary spherical thin-walled parts according to the embodiment of the present disclosure has advantages such as strong adaptability, high operational flexibility, and high machining precision.

In addition, the mirror milling machining equipment for large-scale rotary spherical thin-walled parts according to the above-mentioned embodiment of the present disclosure may further have the following additional technical features.

According to an embodiment of the present disclosure, the machining positioning assembly further includes a machining radial driver configured to drive the machining radial movable platform, a machining pivotal driver configured to drive the machining pivotal movable platform, and a machining oblique driver configured to drive the machining oblique movable platform; the support positioning assembly further includes a support oblique driver configured to drive the support oblique movable platform; and the annular base is provided with a rotary table driver configured to drive the annular rotary table.

According to an embodiment of the present disclosure, the machining radial driver includes a machining radial drive lead screw and a machining radial drive motor, the machining radial drive motor being mounted at the machining base, and the machining radial drive lead screw being in a transmission connection with the machining radial drive motor and being threaded with a nut of the machining radial movable platform; the machining pivotal driver includes a pivotal drive lead screw, a pivotal drive motor, and a pivotal drive nut, the pivotal drive motor being pivotally mounted at the machining radial movable platform and being in a transmission connection with the pivotal drive lead screw, the pivotal drive lead screw being threaded with the pivotal drive nut, and the pivotal drive nut being pivotally mounted at the machining pivotal movable platform; the machining oblique driver includes a machining oblique drive lead screw and a machining oblique drive motor, the machining oblique drive motor being mounted at the machining radial movable platform, and the machining oblique drive lead screw being in a transmission connection with the machining oblique drive motor and being threaded with a nut of the machining oblique movable platform; the support oblique driver includes a support oblique drive lead screw and a support oblique drive motor, the support oblique drive motor being mounted at the support base, and the support oblique drive lead screw being in a transmission connection with the support oblique drive motor and being threaded with a nut of the support oblique movable platform; and the rotary table driver includes a rotary table motor, a gear, and a gear ring, the gear ring being disposed at the annular base, the rotary table motor being disposed at the annular rotary table, and the gear being in a transmission connection with a motor shaft of the rotary table motor and being engaged with the gear ring.

According to an embodiment of the present disclosure, the machining parallel positioner includes a machining parallel positioning support and a plurality of machining side chains, each of the plurality of machining side chains being connected to the machining parallel positioning support and the machining device, and the machining parallel positioning support being connected to the machining oblique movable platform; and the support parallel positioner includes a supporting parallel positioning support and a plurality of support side chains, each of the plurality of support side chains being connected to the supporting parallel positioning support and the support member, and the supporting parallel positioning support being connected to the support oblique movable platform.

According to an embodiment of the present disclosure, the machining side chain includes a machining hollow motor and a machining ball lead screw, the machining hollow motor being in a transmission connection with the machining ball lead screw, the machining ball lead screw being driven through a rotation of the machining hollow motor to rotate along a central axis and move in an axial direction, the machining hollow motor being connected to the machining parallel positioning support through a first machining hinge, the machining ball lead screw being connected to the machining device through a second machining hinge, five machining side chains being provided, five second machining hinges being provided, four of the five second machining hinges each being a double-revolute-joint hinge, one of the five second machining hinges being a single-revolute-joint hinge, and five first machining hinges being provided and each being a double-revolute-joint hinge; or the machining side chain includes a machining side chain track, a machining side chain slider, a machining side chain connection rod, and a machining slider motor, the machining side chain track being connected to the machining parallel positioning support, the machining side chain slider being slidably disposed at the machining side chain track, the machining slider motor being in a transmission connection with the machining side chain slider, and the machining side chain connection rod having an end connected to the machining side chain slider through the first machining hinge and another end connected to the machining device through the second machining hinge; or the machining side chain includes a machining electric cylinder, a machining retractable rod, and a machining retractable motor, the machining retractable rod being movably disposed in the machining electric cylinder in an axial direction, the machining retractable motor being disposed at the machining electric cylinder and being in a transmission connection with the machining retractable rod, the machining electric cylinder being connected to the machining parallel positioning support through the first machining hinge, the machining retractable rod being connected to the machining device through the second machining hinge, four machining side chains being provided, the second machining hinge being a spherical hinge, four first machining hinges being provided, two of the four first machining hinges being single-revolute-joint hinges having parallel rotation axes, and the remaining two of the four first machining hinges being double-revolute-joint hinges; or the machining side chain includes a machining electric cylinder, a machining retractable rod, and a machining retractable motor, the machining retractable rod being movably disposed in the machining electric cylinder in an axial direction, the machining retractable motor being disposed at the machining electric cylinder and being in a transmission connection with the machining retractable rod, the machining electric cylinder being connected to the machining parallel positioning support through the first machining hinge, the machining retractable rod being connected to the machining device through the second machining hinge, four machining side chains being provided, the second machining hinge being a spherical hinge, four first machining hinges being provided, two of the four first machining hinges being single-revolute-joint hinges having parallel rotation axes, the remaining two of the four first machining hinges being double-revolute-joint hinges, a passive retractable side chain being connected between the machining device and the machining parallel positioning support, the passive retractable side chain including an outer sleeve and a passive retractable rod, the passive retractable rod being movably engaged in the outer sleeve in an axial direction and connected to the machining device through a first passive hinge, the outer sleeve being connected to the machining parallel positioning support through a second passive hinge, the first passive hinge being a double-revolute-joint hinge, and the second passive hinge being a single-revolute-joint hinge.

According to an embodiment of the present disclosure, the support side chain includes a support hollow motor and a support ball lead screw, the support hollow motor being in a transmission connection with the support ball lead screw, the support ball lead screw being driven through a rotation of the support hollow motor to rotate along a central axis and move in an axial direction, the support hollow motor being connected to the supporting parallel positioning support through a first support hinge, the support ball lead screw being connected to the support member through a second support hinge, three support side chains being provided, the first support hinge being a single-revolute-joint hinge, the second support hinge being a double-revolute-joint hinge, and the support member being provided with a plurality of support protrusions; or the support side chain includes a support side chain track, a support side chain slider, a support side chain connection rod, and a support slider motor, the support side chain track being connected to the supporting parallel positioning support, the support side chain slider being slidably disposed at the support side chain track, the support slider motor being in a transmission connection with the support side chain slider, the support side chain connection rod having an end connected to the support side chain slider through the first support hinge and another end connected to the support member through the second support hinge, three support side chains being provided, three first support hinges being provided and each being a single-revolute-joint hinge, three second support hinges being provided and each being a spherical hinge, and the support member being provided with a plurality of support protrusions; or the support side chain includes a support electric cylinder, a support retractable rod, and a support retractable motor, the support retractable rod being movably disposed in the support electric cylinder in an axial direction, the support retractable motor being disposed at the support electric cylinder and in a transmission connection with the support retractable rod, the support electric cylinder being connected to the supporting parallel positioning support through the first support hinge, the support retractable rod being connected to the support member through the second support hinge, three support side chains being provided, each of the first support hinge and the second support hinge being a double-revolute-joint hinge, a plane where rotation axes of two revolute joints of the first support hinge are located being parallel to a plane where rotation axes of two revolute joints of the second support hinge are located, the support member being a ball-joint support member or including a support member base and a support member body provided with a plurality of support protrusions, and the support member body being connected to the support member base through a spherical hinge or a double-revolute-joint hinge.

According to an embodiment of the present disclosure, the support oblique movable platform is provided with a support chordwise track extending in a chordwise direction of the annular rotary table, the support chordwise track being provided with a support chordwise movable platform slidably engaged with the support chordwise track, the support parallel positioner being disposed at the support chordwise movable platform, and the support oblique movable platform being provided with a support chordwise driver configured to drive the support chordwise movable platform.

According to an embodiment of the present disclosure, the support chordwise driver includes a support chordwise drive motor and a support chordwise drive lead screw, the support chordwise drive motor being disposed at the support oblique movable platform, the support chordwise drive lead screw being in a transmission connection with the support chordwise drive motor, and the support chordwise drive lead screw being threaded with a nut of the support chordwise movable platform.

According to an embodiment of the present disclosure, the support member is rotatably mounted at the support parallel positioner through a support member hinge.

According to an embodiment in a second aspect of the present disclosure, a corresponding control method for the mirror milling machining equipment for large-scale rotary spherical thin-walled parts according to the embodiment in the first aspect of the present disclosure is provided. The corresponding control method includes the following steps: S1, mounting the to-be-machined part at the annular rotary table; S2, driving, by the machining positioning assembly, the machining device to position the machining device at a to-be-machined surface of the to-be-machined part; S3, driving, by the support positioning assembly, the support member to position the support member at a position coincident with an axis of the machining device; S4, driving, by the annular rotary table, the to-be-machined part to rotate, for completing machining of one parallel of the to-be-machined part; S5, driving, by the machining positioning assembly, the machining device and driving, by the support positioning assembly, the support member, to move the machining device and the support member to a next parallel of the to-be-machined part; and S6, repeating step S4 and step S5, until machining of a surface of the to-be-machined part is completed.

The corresponding control method for the mirror milling machining equipment for large-scale rotary spherical thin-walled parts according to the embodiment of the present disclosure has advantages such as strong adaptability, high operational flexibility, and high machining precision by utilizing the mirror milling machining equipment for large-scale rotary spherical thin-walled parts according to the embodiment in the first aspect of the present disclosure.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become apparent and more understandable from the description of embodiments taken in conjunction with the following accompanying drawings, in which:

FIG. 1 is a schematic structural diagram of a mirror milling machining equipment for large-scale rotary spherical thin-walled parts according to an embodiment of the present disclosure.

FIG. 2 is a schematic structural diagram of a mirror milling machining equipment for large-scale rotary spherical thin-walled parts according to an embodiment of the present disclosure.

FIG. 3 is a schematic structural diagram of a machining positioning assembly of a mirror milling machining equipment for large-scale rotary spherical thin-walled parts according to an exemplary embodiment of the present disclosure.

FIG. 4 is a schematic structural diagram of a machining parallel positioner of a machining positioning assembly of a mirror milling machining equipment for large-scale rotary spherical thin-walled parts according to an exemplary embodiment of the present disclosure.

FIG. 5 is a schematic structural diagram of a machining positioning assembly of a mirror milling machining equipment for large-scale rotary spherical thin-walled parts according to another exemplary embodiment of the present disclosure.

FIG. 6 is a schematic structural diagram of a machining positioning assembly of a mirror milling machining equipment for large-scale rotary spherical thin-walled parts according to yet another exemplary embodiment of the present disclosure.

FIG. 7 is a schematic structural diagram of a support positioning assembly of a mirror milling machining equipment for large-scale rotary spherical thin-walled parts according to an exemplary embodiment of the present disclosure.

FIG. 8 is a schematic structural diagram of a support parallel positioner of a support positioning assembly of a mirror milling machining equipment for large-scale rotary spherical thin-walled parts according to an exemplary embodiment of the present disclosure.

FIG. 9 is a schematic structural diagram of a support positioning assembly of a mirror milling machining equipment for large-scale rotary spherical thin-walled parts according to another exemplary embodiment of the present disclosure.

FIG. 10 is a schematic structural diagram of a support parallel positioner of a support positioning assembly of a mirror milling machining equipment for large-scale rotary spherical thin-walled parts according to another exemplary embodiment of the present disclosure.

FIG. 11 is a schematic structural diagram of a support positioning assembly of a mirror milling machining equipment for large-scale rotary spherical thin-walled parts according to yet another exemplary embodiment of the present disclosure.

FIG. 12 is a schematic structural diagram of a support positioning assembly of a mirror milling machining equipment for large-scale rotary spherical thin-walled parts according to still yet another exemplary embodiment of the present disclosure.

FIG. 13 is a schematic structural diagram of a support positioning assembly of a mirror milling machining equipment for large-scale rotary spherical thin-walled parts according to still yet another exemplary embodiment of the present disclosure.

FIG. 14 is a schematic structural diagram of an annular base and an annular rotary table of a mirror milling machining equipment for large-scale rotary spherical thin-walled parts according to an embodiment of the present disclosure.

FIG. 15 is a flowchart of a corresponding control method for a mirror milling machining equipment for large-scale rotary spherical thin-walled parts according to an embodiment of the present disclosure.

Reference numerals of the accompanying drawings: mirror milling machining equipment 1 for large-scale rotary spherical thin-walled parts, annular base 100, gear ring 110, annular rotary table 200, rotary table motor 210, gear 220, machining positioning assembly 300, machining base 310, machining radial track 311, machining radial drive motor 312, machining radial drive lead screw 313, machining radial movable platform 320, machining pivotal movable platform 330, machining oblique track 331, machining oblique drive motor 332, machining oblique movable platform 340, machining parallel positioner 350, machining parallel positioning support 351, machining side chain 352, machining hollow motor 3521, machining ball lead screw 3522, machining electric cylinder 3523, machining retractable rod 3524, machining retractable motor 3525, first machining hinge 353, second machining hinge 354, outer sleeve 3551, passive retractable rod 3552, first passive hinge 356, second passive hinge 357, machining vertical movable platform 360, pivotal drive motor 371, pivotal drive lead screw 372, machining device 400, support positioning assembly 500, support base 510, support oblique track 511, support oblique movable platform 520, support chordwise track 521, support chordwise movable platform 530, support parallel positioner 540, supporting parallel positioning support 541, support side chain 542, support side chain track 5421, support side chain slider 5422, support side chain connection rod 5423, support hollow motor 5424, support ball lead screw 5425, support electric cylinder 5426, support retractable rod 5427, support retractable motor 5428, first support hinge 543, second support hinge 544, support member 600, support member hinge 610, to-be-machined part 2

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it should be understood that, the orientation or the position indicated by terms such as “center”, “longitudinal”, “lateral”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation and the position as shown in the drawings, and is only for the convenience of describing the present disclosure and simplifying the description, rather than indicating or implying that the device or element must have a specific orientation, or be constructed and operated in a specific orientation, and therefore cannot be understood as a limitation of the present disclosure. In addition, the features associated with “first” and “second” may explicitly or implicitly include at least one of the features. In the description of the present disclosure, “plurality” means at least two, unless otherwise specifically defined.

In the description of the present disclosure, it should be noted that, unless otherwise clearly stipulated and limited, terms such as “install”, “connect”, “connect to”, and the like should be understood in a broad sense. For example, it may be a fixed connection or a detachable connection or connection as one piece; mechanical connection or electrical connection; direct connection or indirect connection through an intermediate; internal communication of two components. For those skilled in the art, the specific meaning of the above-mentioned terms in the present disclosure can be understood according to specific circumstances.

A mirror milling machining equipment 1 for large-scale rotary spherical thin-walled parts according to the embodiments of the present disclosure is described below with reference to the accompanying drawings.

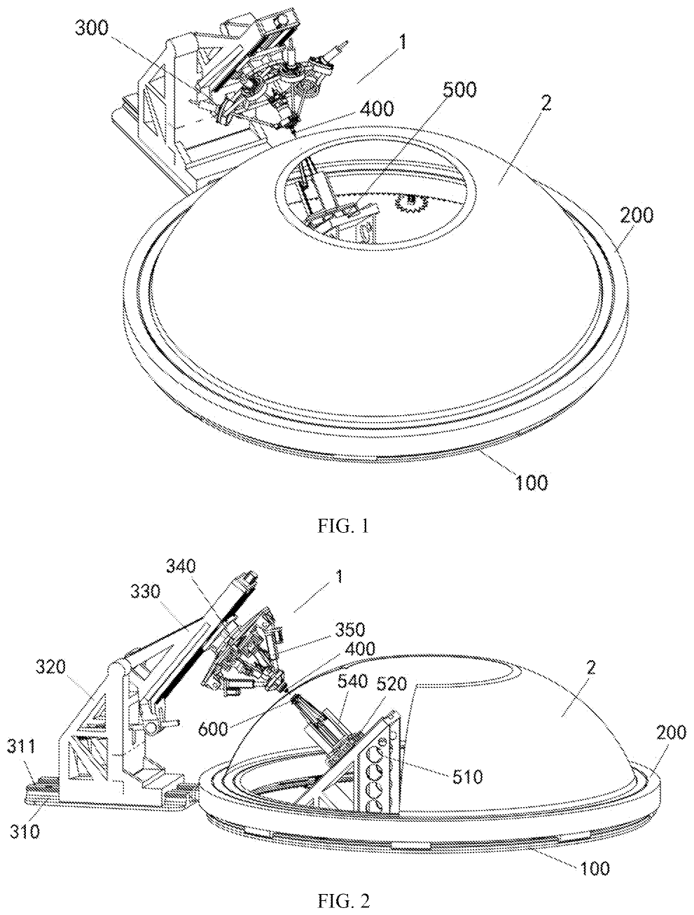

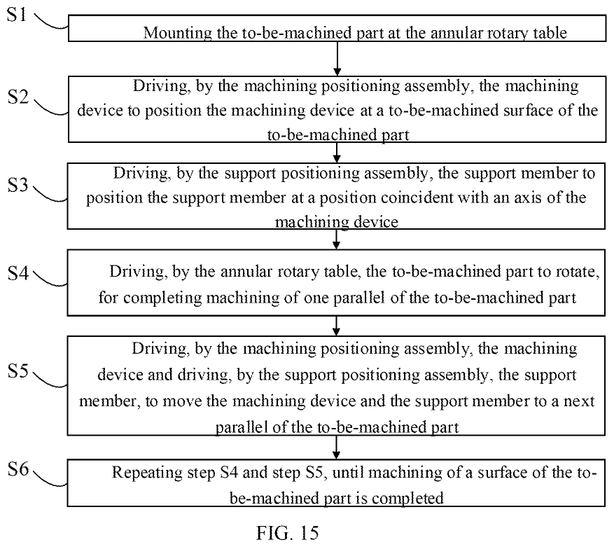

As illustrated in FIG. 1 to FIG. 15, the mirror milling machining equipment 1 for large-scale rotary spherical thin-walled parts according to the embodiments of the present disclosure includes an annular base 100, an annular rotary table 200, a machining positioning assembly 300, a machining device 400, a support positioning assembly 500, and a support member 600.

The annular rotary table 200 is rotatably disposed at the annular base 100. The annular rotary table 200 is adapted for placement of a to-be-machined part 2 and adapted to drive the to-be-machined part 2 to rotate together.

The machining positioning assembly 300 includes a machining base 310, a machining radial movable platform 320, a machining pivotal movable platform 330, a machining oblique movable platform 340, and a machining parallel positioner 350. The machining base 310 is disposed at a radial outer side of the annular rotary table 200 and provided with a machining radial track 311 positioned in a radial direction of the annular rotary table 200. The machining radial movable platform 320 is slidably disposed at the machining radial track 311. The machining pivotal movable platform 330 is pivotally disposed at the machining radial movable platform 320 and has a rotation axis perpendicular to the radial direction of the annular rotary table 200. The machining pivotal movable platform 330 is provided with a machining oblique track 331 extending, in the radial direction of the annular rotary table 200, obliquely upwards from outside to inside. The machining oblique movable platform 340 is slidably disposed at the machining oblique track 331. The machining parallel positioner 350 is mounted at the machining oblique movable platform 340.

The machining device 400 is mounted at the machining parallel positioner 350.

The support positioning assembly 500 includes a support base 510, a support oblique movable platform 520, and a support parallel positioner 540. The support base 510 is disposed at a radial inner side of the annular rotary table 200 and provided with a support oblique track 511. The support oblique track 511 extends, in the radial direction of the annular rotary table 200, obliquely upwards from outside to inside. The support oblique movable platform 520 is slidably disposed at the support oblique track 511. The support parallel positioner 540 is mounted at the support oblique movable platform 520.

The support member 600 is mounted at the support parallel positioner 540.

With the mirror milling machining equipment 1 for large-scale rotary spherical thin-walled parts according to the embodiments of the present disclosure, the to-be-machined part 2 may be driven to rotate by a rotation of the annular rotary table 200 at the annular base 100, and thus a position of a to-be-machined busbar of the to-be-machined part 2 may be adjusted to a position of the machining device 400. A position of the machining device 400 in a radial direction of the to-be-machined part 2 may be adjusted by a radial movement of the machining radial movable platform 320. An angle of the machining device 400 may be adjusted by a rotation of the machining pivotal movable platform 330. A position of the machining device 400 at the busbar of the to-be-machined part 2 may be adjusted by an oblique movement of the machining oblique movable platform 340. A fine position adjustment of the machining device 400 in several degrees of freedom may be realized by the machining parallel positioner 350. A position of the support member 600 at the busbar of the to-be-machined part 2 may be adjusted by an oblique movement of the support oblique movable platform 520. A fine adjustment of the support member 600 in several degrees of freedom may be realized by the support parallel positioner 540.

In this way, an axis of the support member 600 can be kept coincide with an axis of the machining device 400 during machining of the machining device 400. Therefore, support for a machining position of the machining device 400 can be maintained by the support member 600, which prevents a deformation of the to-be-machined part 2 having a thin-walled feature.

In addition, positioning of the machining device 400 and the support member 600 is realized using the multi-axis parallel positioner. Compared with a machining method in the related art, such a machining method allows the grid-featured mirror milling machining equipment 1 at an outer side of large-scale rotary spherical thin-walled parts to have higher adaptability to a workspace and an environment, which improves flexibility of a machining operation, facilitates realization of overall in-situ machining of large-scale and complex components, and helps ensure machining precision. In addition, resource conflicts can be alleviated.

In addition, with the annular base 100 and the annular rotary table 200, rotary parts can be adapted to be disposed at the annular rotary table 200. Therefore, the grid-featured mirror milling machining equipment 1 at the outer side of large-scale rotary spherical thin-walled parts is applicable to machining of the rotary parts. In addition, driving the to-be-machined part by a rotation of the annular rotary table 200 can quickly rotate the part to a position for machining without moving the machining positioning assembly 300 and the support positioning assembly 500 as a whole. Therefore, an improvement of a machining efficiency of the grid-featured mirror milling machining equipment 1 at the outer side of large-scale rotary spherical thin-walled parts can be facilitated.

In addition, since an angle of the machining oblique track 331 is adjusted by pivoting the machining pivotal movable platform 330, the angle of the machining device 400 is adjusted, which can facilitate an adjustment of a position and an angle of the machining device 400 at a spherical part. In this way, the machining device 400 can be more easily adapted to the spherical part, which facilitates machining performed by the mirror milling machining equipment 1 for large-scale rotary spherical thin-walled parts on the spherical part. Therefore, the mirror milling machining equipment 1 for large-scale rotary spherical thin-walled parts according to the embodiments of the present disclosure has advantages such as strong adaptability, high operational flexibility, and high machining precision.

The mirror milling machining equipment 1 for large-scale rotary spherical thin-walled parts according to exemplary embodiments of the present disclosure is described below with reference to the accompanying drawings.

In some exemplary embodiments of the present disclosure, as illustrated in FIG. 1 to FIG. 15, the mirror milling machining equipment 1 for large-scale rotary spherical thin-walled parts according to the embodiments of the present disclosure includes the annular base 100, the annular rotary table 200, the machining positioning assembly 300, the machining device 400, the support positioning assembly 500, and the support member 600.

In an exemplary embodiment of the present disclosure, as illustrated in FIG. 1 to FIG. 6 and FIG. 14, the machining positioning assembly 300 further includes a machining radial driver configured to drive the machining radial movable platform 320, a machining pivotal driver configured to drive the machining pivotal movable platform 330, and a machining oblique driver configured to drive the machining oblique movable platform 340. The support positioning assembly 500 further includes a support oblique driver configured to drive the support oblique movable platform 520. The annular base 100 is provided with a rotary table driver configured to drive the annular rotary table 200. In this way, driving of the machining radial movable platform 320, the machining oblique movable platform 340, the support oblique movable platform 520, and the annular rotary table 200 can be facilitated, which facilitates precise control of positions of the machining device 400, the support member 600, and the to-be-machined part 2.

In an exemplary embodiment of the present disclosure, as illustrated in FIG. 1 to FIG. 6, the machining radial driver includes a machining radial drive lead screw 313 and a machining radial drive motor 312. The machining radial drive motor 312 is mounted at the machining base 310. The machining radial drive lead screw 313 is in a transmission connection with the machining radial drive motor 312 and is threaded with a nut of the machining radial movable platform 320.

The machining oblique driver includes a machining oblique drive lead screw and a machining oblique drive motor 332. The machining oblique drive motor 332 is mounted at the machining pivotal movable platform 330. The machining oblique drive lead screw is in a transmission connection with the machining oblique drive motor 332 and is threaded with a nut of the machining oblique movable platform 340.

The support oblique driver includes a support oblique drive lead screw and a support oblique drive motor. The support oblique drive motor is mounted at the support base 510. The support oblique drive lead screw is in a transmission connection with the support oblique drive motor and is threaded with a nut of the support oblique movable platform 520.

In this way, since the lead screw is threaded with the nut of the movable platform, a rotation of the lead screw driven by the motor is converted into a movement of the movable platform in an axial direction of the lead screw. Therefore, driving for the machining radial movable platform 320, the machining oblique movable platform 340, and the support oblique movable platform 520 is realized.

The machining pivotal driver includes a pivotal drive lead screw 372, a pivotal drive motor 371, and a pivotal drive nut. The pivotal drive motor 371 is pivotally mounted at the machining radial movable platform 320 and is in a transmission connection with the pivotal drive lead screw 372. The pivotal drive lead screw 372 is threaded with the pivotal drive nut. The pivotal drive nut is pivotally mounted at the machining pivotal movable platform 330.

In this way, since the lead screw is threaded with the nut, a rotation of the screw driven by the motor is converted into a movement of the nut in an axial direction of the lead screw. Therefore, the machining pivotal movable platform 330 is pivoted through the movement of the nut.

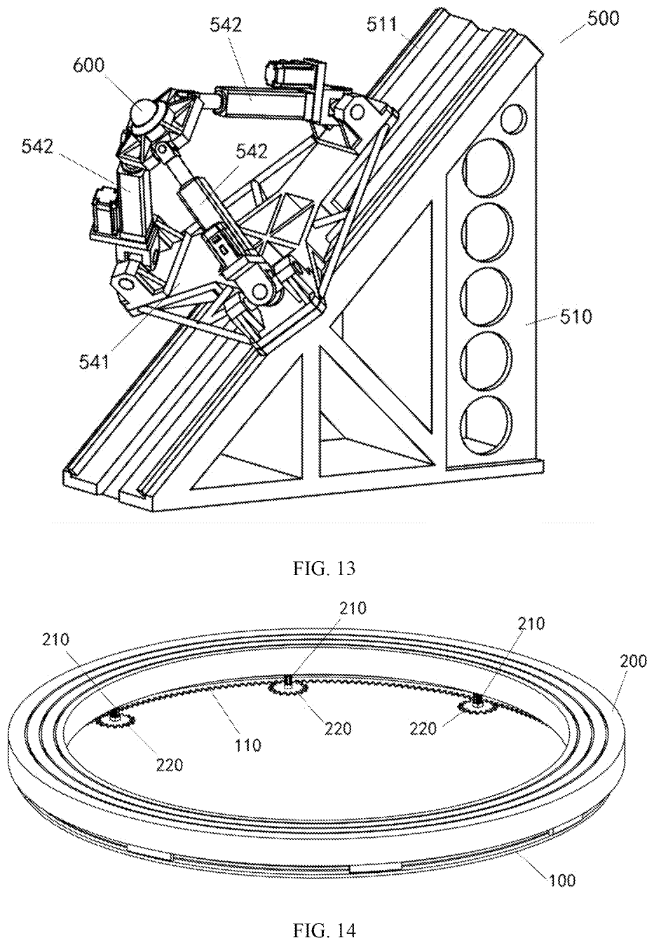

As illustrated in FIG. 14, the rotary table driver includes a rotary table motor 210, a gear 220, and a gear ring 110. The gear ring 110 is disposed at the annular base 100. The rotary table motor 210 is disposed at the annular rotary table 200. The gear 220 is in a transmission connection with the rotary table motor 210 and is engaged with the gear ring 110. In an exemplary embodiment of the present disclosure, a plurality of rotary table motors 210 may be provided and arranged at intervals in a circumferential direction of the annular rotary table 200. A plurality of gears 220 may be provided and in a transmission connection with the plurality of rotary table motors 210 in a one-to-one correspondence. In this way, since the gear 220 is engaged with the gear ring 110, a rotation of the gear 220 driven by the motor can be converted into a rotation of the gear ring 110, realizing driving for the annular rotary table 200.

In some embodiments, as illustrated in FIG. 1 to FIG. 6, the machining parallel positioner 350 includes a machining parallel positioning support 351 and a plurality of machining side chains 352. Each of the plurality of machining side chains 352 is connected to the machining parallel positioning support 351 and the machining device 400. The machining parallel positioning support 351 is connected to the machining oblique movable platform 340. In an exemplary embodiment of the present disclosure, the machining parallel positioner 350 is a four-axis parallel positioner or a five-axis parallel positioner. That is, four or five machining side chains 352 are provided.

It should be understood by those skilled in the art that since machining of large-scale rotary spherical thin-walled parts does not require machining of grid features as compared to machining of grid features of an outer surface of a large-scale rotary cone, requirements of a degree of freedom of the machining positioning assembly 300 can be reduced, e.g., four degrees of freedom. Therefore, a degree of freedom for a cutting movement along the workpiece can be omitted.

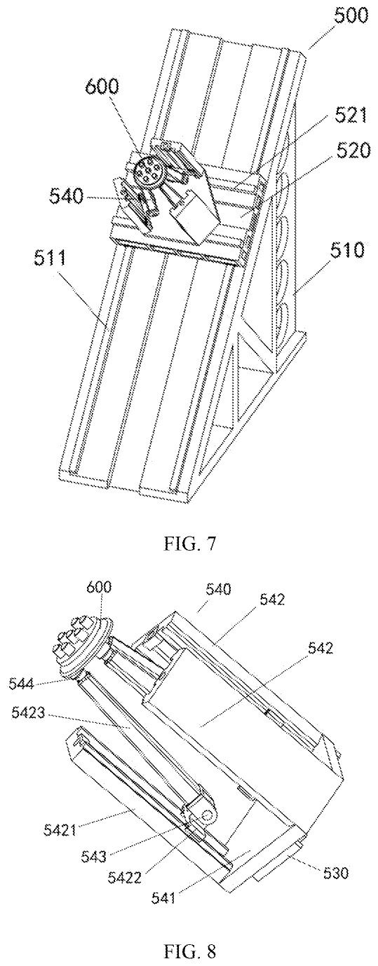

As illustrated in FIG. 7 to FIG. 13, the support parallel positioner 540 includes a supporting parallel positioning support 541 and a plurality of support side chains 542. Each of the plurality of support side chains 542 is connected to the supporting parallel positioning support 541 and the support member 600. The supporting parallel positioning support 541 is connected to the support oblique movable platform 520. In an exemplary embodiment of the present disclosure, the support parallel positioner 540 is a three-axis parallel positioner or a five-axis parallel positioner. That is, three or five support side chains 542 are provided. In some embodiments, the support parallel positioner 540 is the three-axis parallel positioner. That is, three support side chains 542 are provided.

In this way, the plurality of side chains can be connected by the support, which facilitates multi-axis parallel positioning for the machining device 400 and the support member 600.

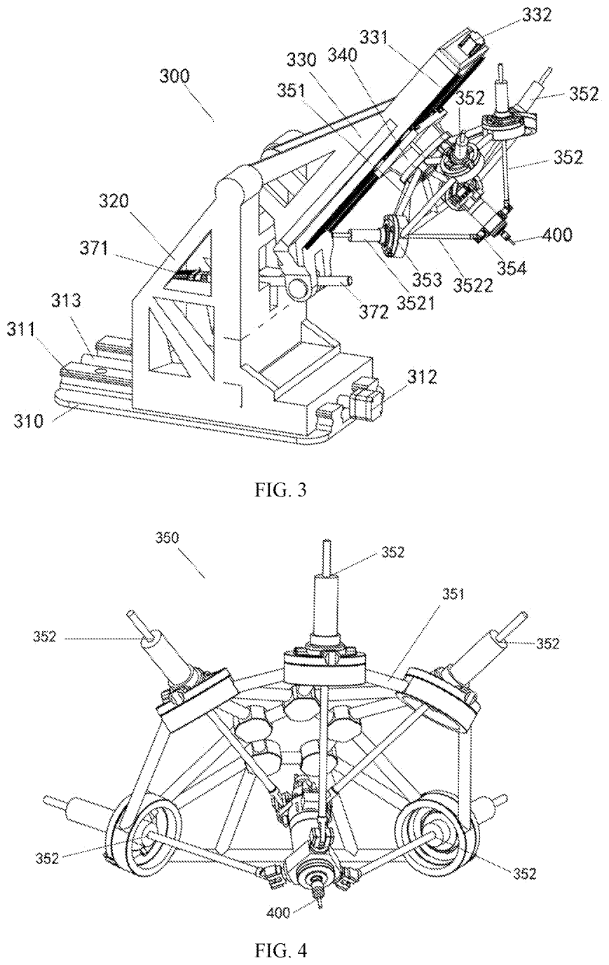

In some embodiments, as illustrated in FIG. 3 and FIG. 4, the machining side chain 352 includes a machining hollow motor 3521 and a machining ball lead screw 3522. The machining hollow motor 3521 is in a transmission connection with the machining ball lead screw 3522. The machining ball lead screw 3522 is driven through a rotation of the machining hollow motor 3521 to rotate along a central axis and move in an axial direction. The machining hollow motor 3521 is connected to the machining parallel positioning support 351 through a first machining hinge 353. The machining ball lead screw 3522 is connected to the machining device 400 through a second machining hinge 354. In an exemplary embodiment of the present disclosure, five machining side chains 352 are provided. Four of five second machining hinges 354 each are a double-revolute-joint hinge. One of the five second machining hinges 354 is a single-revolute-joint hinge. Five first machining hinges 353 each are a double-revolute-joint hinge.

In some other embodiments, the machining side chain includes a machining side chain track, a machining side chain slider, a machining side chain connection rod, and a machining slider motor. The machining side chain track is connected to the machining parallel positioning support. The machining side chain slider is slidably disposed at the machining side chain track. The machining slider motor is in a transmission connection with the machining side chain slider. The machining side chain connection rod has an end connected to the machining side chain slider through the first machining hinge and another end connected to the machining device the second machining hinge. In an exemplary embodiment of the present disclosure, the machining slider motor may be in the transmission connection with the machining side chain slider through a lead screw threaded with the machining side chain slider.

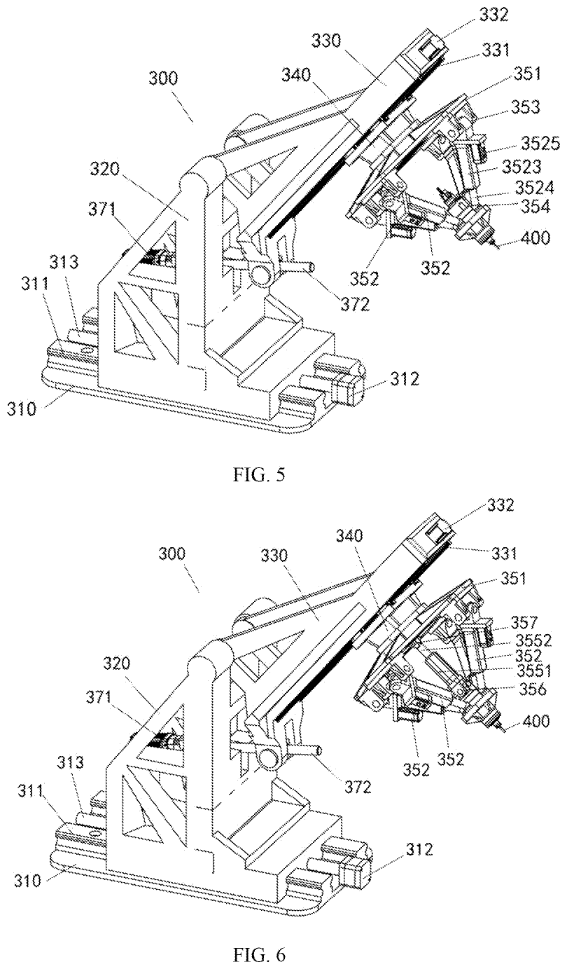

In some other embodiments, as illustrated in FIG. 5, the machining side chain 352 includes a machining electric cylinder 3523, a machining retractable rod 3524, and a machining retractable motor 3525. The machining retractable rod 3524 is movably disposed in the machining electric cylinder 3523 in an axial direction. The machining retractable motor 3525 is disposed at the machining electric cylinder 3523 and is in a transmission connection with the machining retractable rod 3524. The machining electric cylinder 3523 is connected to the machining parallel positioning support 351 through the first machining hinge 353. The machining retractable rod 3524 is connected to the machining device 400 through the second machining hinge 354. In an exemplary embodiment of the present disclosure, two of four first machining hinges 353 are single-revolute-joint hinges having parallel rotation axes, while the remaining two of the four first machining hinges 353 are double-revolute-joint hinges. The second machining hinge 354 is a spherical hinge.

In some other embodiments, as illustrated in FIG. 6, the machining side chain 352 includes a machining electric cylinder 3523, a machining retractable rod 3524, and a machining retractable motor 3525. The machining retractable rod 3524 is movably disposed in the machining electric cylinder 3523 in an axial direction. The machining retractable motor 3523 is disposed at the machining electric cylinder 3523 and is in a transmission connection with the machining retractable rod 3524. The machining electric cylinder 3523 is connected to the machining parallel positioning support 351 through the first machining hinge 353. The machining retractable rod 3524 is connected to the machining device 400 through the second machining hinge 354. In an exemplary embodiment of the present disclosure, two of four first machining hinges 353 are single-revolute-joint hinges having parallel rotation axes, while the remaining two of the four first machining hinges 353 are double-revolute-joint hinges. The second machining hinge 354 is a spherical hinge. A passive retractable side chain is connected between the machining device 400 and the machining parallel positioning support 351. The passive retractable side chain includes an outer sleeve 3551 and a passive retractable rod 3552. The passive retractable rod 3552 is movably engaged in the outer sleeve 3551 in an axial direction and connected to the machining device 400 through a first passive hinge 356. The outer sleeve 3551 is connected to the machining parallel positioning support 351 by a second passive hinge 357. The first passive hinge 356 is a double-revolute-joint hinge. The second passive hinge 357 is a single-revolute-joint hinge. In this way, the passive retractable side chain can be used to further guide a movement of the machining device 400, which improves stability and an accuracy of a position of the machining device 400.

In this way, multi-axis driving for the machining device 400 can be realized.

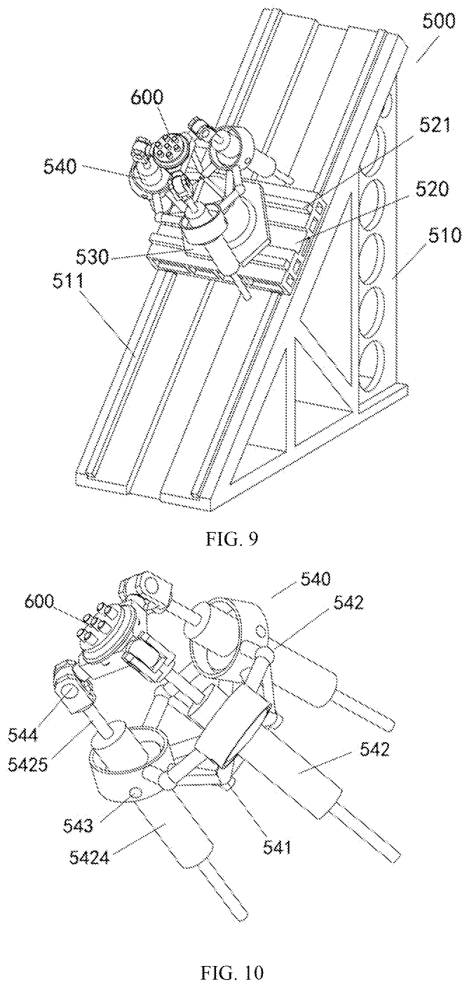

In some embodiments, as illustrated in FIG. 9 and FIG. 10, the support side chain 542 includes a support hollow motor 5424 and a support ball lead screw 5425. The support hollow motor 5424 is in a transmission connection with the support ball lead screw 5425. The support ball lead screw 5425 is driven through a rotation of the support hollow motor 5424 to rotate along a central axis and move in an axial direction. The support hollow motor 5424 is connected to the supporting parallel positioning support 541 through a first support hinge 543. The support ball lead screw 5425 is connected to the support member 600 through a second support hinge 544. In an exemplary embodiment of the present disclosure, as illustrated in FIG. 9 and FIG. 10, three support side chains 542 may be provided. The first support hinge 543 is a single-revolute-joint hinge. The second support hinge 544 is a double-revolute-joint hinge. The support member 600 is provided with a plurality of support protrusions.

In some other embodiments, as illustrated in FIG. 7 and FIG. 8, the support side chain 542 includes a support side chain track 5421, a support side chain slider 5422, a support side chain connection rod 5423, and a support slider motor. The support side chain track 5421 is connected to the supporting parallel positioning support 541. The support side chain slider 5422 is slidably disposed at the support side chain track 5421. The support slider motor is in a transmission connection with the support side chain slider 5422. The support side chain connection rod 5423 has an end connected to the support side chain slider 5422 through the first support hinge 543 and another end connected to the support member 600 through the second support hinge 544. In an exemplary embodiment of the present disclosure, the support slider motor may be in the transmission connection with the support side chain slider 5422 through a lead screw threaded with the support side chain slider 5422. In an exemplary embodiment of the present disclosure, three support side chains 542 are provided. Three first support hinges 543 each are a single-revolute-joint hinge. Three second support hinges 544 each are a spherical hinge. The support member 600 is provided with a plurality of support protrusions.

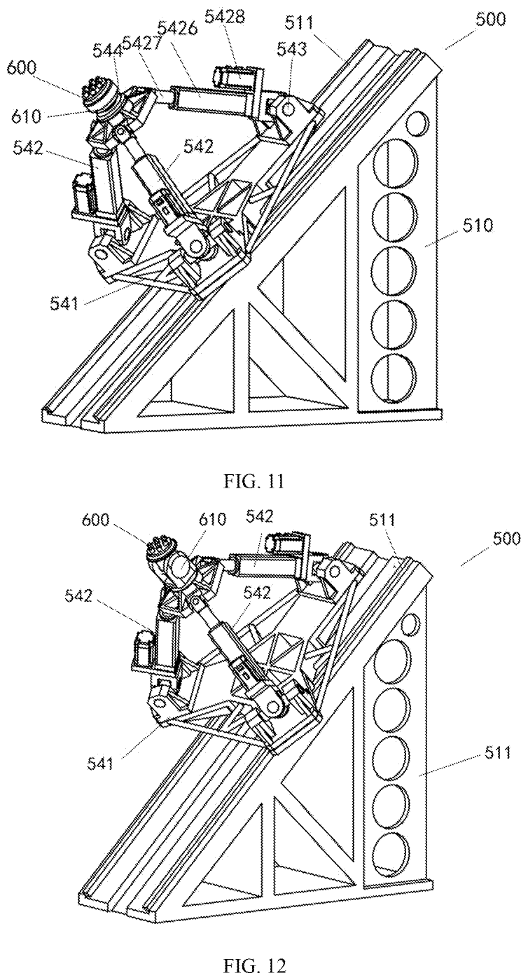

In some other embodiments, as illustrated in FIG. 11 to FIG. 13, the support side chain 542 includes a support electric cylinder 5426, a support retractable rod 5427, and a support retractable motor 5428. The support retractable rod 5427 is movably disposed in the support electric cylinder 5426 in an axial direction. The support retractable motor 5428 is disposed at the support electric cylinder 5426 and in a transmission connection with the support retractable rod 5427. The support electric cylinder 5426 is connected to the supporting parallel positioning support 541 through the first support hinge 543. The support retractable rod 5427 is connected to the support member 600 through the second support hinge 544. Three support side chains 542 are provided. Each of the first support hinge 543 and the second support hinge 544 is a double-revolute-joint hinge. A plane where rotation axes of two revolute joints of the first support hinge 543 are located is parallel to a plane where rotation axes of two revolute joints of the second support hinge 544 are located. The support member 600 is a ball-joint support member or includes a support member base and a support member body provided with a plurality of support protrusions. The support member body is connected to the support member base through a support member hinge 610. The support member hinge 610 is a spherical hinge or a double-revolute-joint hinge.

In this way, multi-axis driving for the support member 600 can be realized.

FIG. 7 and FIG. 9 each illustrate the mirror milling machining equipment 1 for large-scale rotary spherical thin-walled parts according to some embodiments of the present disclosure. As illustrated in FIG. 7 and FIG. 9, the support oblique movable platform 520 is provided with a support chordwise track 521 extending in a chordwise direction of the annular rotary table 200. The support chordwise track 521 is provided with a support chordwise movable platform 530 slidably engaged with the support chordwise track 521. The support parallel positioner 540 is disposed at the support chordwise movable platform 530. The support oblique movable platform 520 is provided with a support chordwise driver configured to drive the support chordwise movable platform 530. The support chordwise driver includes a support chordwise drive motor and a support chordwise drive lead screw. The support chordwise drive motor is disposed at the support oblique movable platform 520. The support chordwise drive lead screw is in a transmission connection with the support chordwise drive motor. The support chordwise drive lead screw is threaded with a nut of the support chordwise movable platform 530. In this way, the support member 600 can be driven to move in a chordwise direction of the to-be-machined part 2 through a movement of the support chordwise movable platform 530, which further increases a degree of freedom of a position adjustment of the support member 600.

In some embodiments, as illustrated in FIG. 11 and FIG. 12, the support member 600 is rotatably mounted at the support parallel positioner 540 through a support member hinge 610. In an exemplary embodiment of the present disclosure, as illustrated in FIG. 11, the support member hinge 610 may be a spherical hinge. Or, as illustrated in FIG. 12, the support member hinge 610 may be a double-revolute-joint hinge. The support member 600 may include the plurality of support protrusions. In this way, the support member 600 can be easily attached to an inner surface of the spherical part.

In some other embodiments, as illustrated in FIG. 13, the support member 600 may also be in a ball-joint shape. In this way, the support member 600 can be easily attached to the inner surface of the spherical part.

A corresponding control method for the mirror milling machining equipment 1 for large-scale rotary spherical thin-walled parts according to the above-mentioned embodiments of the present disclosure is described below. The corresponding control method includes the following steps.

At S1, the to-be-machined part is mounted at the annular rotary table.

At S2, the machining device is driven by the machining positioning assembly to position the machining device at a to-be-machined surface of the to-be-machined part.

At S3, the support member is driven by the support positioning assembly to position the support member at a position coincident with an axis of the machining device.

At S4, the to-be-machined part is driven by the annular rotary table to rotate, for completing machining of one parallel of the to-be-machined part.

At S5, the machining device is driven by the machining positioning assembly, and the support member is driven by the support positioning assembly, to move the machining device and the support member to a next parallel of the to-be-machined part.

At S6, step S4 and step S5 are repeated, until machining of a surface of the to-be-machined part is completed.

The corresponding control method for the mirror milling machining equipment 1 for large-scale rotary spherical thin-walled parts according to the embodiments of the present disclosure has advantages such as strong adaptability, high operational flexibility, and high machining precision by utilizing the mirror milling machining equipment 1 for large-scale rotary spherical thin-walled parts according to the above-mentioned embodiments of the present disclosure.

Other components and operations of the mirror milling machining equipment 1 for large-scale rotary spherical thin-walled parts according to the embodiments of the present disclosure are known to those skilled in the art, and thus details thereof will be omitted here.

Reference throughout this specification to phrases such as “an embodiment”, “some embodiments”, “an illustrative embodiment”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A mirror milling machining equipment for large-scale rotary spherical thin-walled parts, the mirror milling machining equipment comprising:
an annular base;
an annular rotary table rotatably disposed at the annular base, the annular rotary table being adapted for placement of a to-be-machined part and adapted to drive the to-be-machined part to rotate together;
a machining positioning assembly comprising a machining base, a machining radial movable platform, a machining pivotal movable platform, a machining oblique movable platform, and a machining parallel positioner, the machining base being disposed at a radial outer side of the annular rotary table and provided with a machining radial track positioned in a radial direction of the annular rotary table, the machining radial movable platform being slidably disposed at the machining radial track, the machining pivotal movable platform being pivotally disposed at the machining radial movable platform and having a rotation axis perpendicular to the radial direction of the annular rotary table, the machining pivotal movable platform being provided with a machining oblique track extending, in the radial direction of the annular rotary table, obliquely upwards from outside to inside, the machining oblique movable platform being slidably disposed at the machining oblique track, and the machining parallel positioner being mounted at the machining oblique movable platform;
a machining device mounted at the machining parallel positioner;
a support positioning assembly comprising a support base, a support oblique movable platform, and a support parallel positioner, the support base being disposed at a radial inner side of the annular rotary table and provided with a support oblique track, the support oblique track extending, in the radial direction of the annular rotary table, obliquely upwards from outside to inside, the support oblique movable platform being slidably disposed at the support oblique track, and the support parallel positioner being mounted at a support oblique movable platform; and
a support member mounted at the support parallel positioner.

2. The mirror milling machining equipment according to claim 1, wherein:
the machining positioning assembly further comprises a machining radial driver configured to drive the machining radial movable platform, a machining pivotal driver configured to drive the machining pivotal movable platform, and a machining oblique driver configured to drive the machining oblique movable platform;
the support positioning assembly further comprises a support oblique driver configured to drive the support oblique movable platform; and
the annular base is provided with a rotary table driver configured to drive the annular rotary table.

3. The mirror milling machining equipment according to claim 2, wherein:
the machining radial driver comprises a machining radial drive lead screw and a machining radial drive motor, the machining radial drive motor being mounted at the machining base, and the machining radial drive lead screw being in a transmission connection with the machining radial drive motor and being threaded with a nut of the machining radial movable platform;
the machining pivotal driver comprises a pivotal drive lead screw, a pivotal drive motor, and a pivotal drive nut, the pivotal drive motor being pivotally mounted at the machining radial movable platform and being in a transmission connection with the pivotal drive lead screw, the pivotal drive lead screw being threaded with the pivotal drive nut, and the pivotal drive nut being pivotally mounted at the machining pivotal movable platform;
the machining oblique driver comprises a machining oblique drive lead screw and a machining oblique drive motor, the machining oblique drive motor being mounted at the machining pivotal movable platform, and the machining oblique drive lead screw being in a transmission connection with the machining oblique drive motor and being threaded with a nut of the machining oblique movable platform;
the support oblique driver comprises a support oblique drive lead screw and a support oblique drive motor, the support oblique drive motor being mounted at the support base, and the support oblique drive lead screw being in a transmission connection with the support oblique drive motor and being threaded with a nut of the support oblique movable platform; and
the rotary table driver comprises a rotary table motor, a gear, and a gear ring, the gear ring being disposed at the annular base, the rotary table motor being disposed at the annular rotary table, and the gear being in a transmission connection with a motor shaft of the rotary table motor and being engaged with the gear ring.

4. The mirror milling machining equipment according to claim 1, wherein:
the machining parallel positioner comprises a machining parallel positioning support and a plurality of machining side chains, each of the plurality of machining side chains being connected to the machining parallel positioning support and the machining device, and the machining parallel positioning support being connected to the machining oblique movable platform; and
the support parallel positioner comprises a supporting parallel positioning support and a plurality of support side chains, each of the plurality of support side chains being connected to the supporting parallel positioning support and the support member, and the supporting parallel positioning support being connected to the support oblique movable platform.

5. The mirror milling machining equipment according to claim 4, wherein:
the machining side chain comprises a machining hollow motor and a machining ball lead screw, the machining hollow motor being in a transmission connection with the machining ball lead screw, the machining ball lead screw being driven through a rotation of the machining hollow motor to rotate along a central axis and move in an axial direction, the machining hollow motor being connected to the machining parallel positioning support through a first machining hinge, the machining ball lead screw being connected to the machining device through a second machining hinge, five machining side chains being provided, five second machining hinges being provided, four of the five second machining hinges each being a double-revolute-joint hinge, one of the five second machining hinges being a single-revolute-joint hinge, and five first machining hinges being provided and each being a double-revolute-joint hinge; or
the machining side chain comprises a machining side chain track, a machining side chain slider, a machining side chain connection rod, and a machining slider motor, the machining side chain track being connected to the machining parallel positioning support, the machining side chain slider being slidably disposed at the machining side chain track, the machining slider motor being in a transmission connection with the machining side chain slider, and the machining side chain connection rod having an end connected to the machining side chain slider through the first machining hinge and another end connected to the machining device through the second machining hinge; or
the machining side chain comprises a machining electric cylinder, a machining retractable rod, and a machining retractable motor, the machining retractable rod being movably disposed in the machining electric cylinder in an axial direction, the machining retractable motor being disposed at the machining electric cylinder and being in a transmission connection with the machining retractable rod, the machining electric cylinder being connected to the machining parallel positioning support through the first machining hinge, the machining retractable rod being connected to the machining device through the second machining hinge, four machining side chains being provided, the second machining hinge being a spherical hinge, four first machining hinges being provided, two of the four first machining hinges being single-revolute-joint hinges having parallel rotation axes, and the remaining two of the four first machining hinges being double-revolute-joint hinges; or
the machining side chain comprises a machining electric cylinder, a machining retractable rod, and a machining retractable motor, the machining retractable rod being movably disposed in the machining electric cylinder in an axial direction, the machining retractable motor being disposed at the machining electric cylinder and being in a transmission connection with the machining retractable rod, the machining electric cylinder being connected to the machining parallel positioning support through the first machining hinge, the machining retractable rod being connected to the machining device through the second machining hinge, four machining side chains being provided, the second machining hinge being a spherical hinge, four first machining hinges being provided, two of the four first machining hinges being single-revolute-joint hinges having parallel rotation axes, the remaining two of the four first machining hinges being double-revolute-joint hinges, a passive retractable side chain being connected between the machining device and the machining parallel positioning support, the passive retractable side chain comprising an outer sleeve and a passive retractable rod, the passive retractable rod being movably engaged in the outer sleeve in an axial direction and connected to the machining device through a first passive hinge, the outer sleeve being connected to the machining parallel positioning support through a second passive hinge, the first passive hinge being a double-revolute-joint hinge, and the second passive hinge being a single-revolute-joint hinge.

6. The mirror milling machining equipment according to claim 4, wherein:
the support side chain comprises a support hollow motor and a support ball lead screw, the support hollow motor being in a transmission connection with the support ball lead screw, the support ball lead screw being driven through a rotation of the support hollow motor to rotate along a central axis and move in an axial direction, the support hollow motor being connected to the supporting parallel positioning support through a first support hinge, the support ball lead screw being connected to the support member through a second support hinge, three support side chains being provided, the first support hinge being a single-revolute-joint hinge, the second support hinge being a double-revolute-joint hinge, and the support member being provided with a plurality of support protrusions; or
the support side chain comprises a support side chain track, a support side chain slider, a support side chain connection rod, and a support slider motor, the support side chain track being connected to the supporting parallel positioning support, the support side chain slider being slidably disposed at the support side chain track, the support slider motor being in a transmission connection with the support side chain slider, the support side chain connection rod having an end connected to the support side chain slider through the first support hinge and another end connected to the support member through the second support hinge, three support side chains being provided, three first support hinges being provided and each being a single-revolute-joint hinge, three second support hinges being provided and each being a spherical hinge, and the support member being provided with a plurality of support protrusions; or
the support side chain comprises a support electric cylinder, a support retractable rod, and a support retractable motor, the support retractable rod being movably disposed in the support electric cylinder in an axial direction, the support retractable motor being disposed at the support electric cylinder and in a transmission connection with the support retractable rod, the support electric cylinder being connected to the supporting parallel positioning support through the first support hinge, the support retractable rod being connected to the support member through the second support hinge, three support side chains being provided, each of the first support hinge and the second support hinge being a double-revolute-joint hinge, a plane where rotation axes of two revolute joints of the first support hinge are located being parallel to a plane where rotation axes of two revolute joints of the second support hinge are located, the support member being a ball-joint support member or comprising a support member base and a support member body provided with a plurality of support protrusions, and the support member body being connected to the support member base through a spherical hinge or a double-revolute-joint hinge.

7. The mirror milling machining equipment according to claim 1, wherein the support oblique movable platform is provided with a support chordwise track extending in a chordwise direction of the annular rotary table, the support chordwise track being provided with a support chordwise movable platform slidably engaged with the support chordwise track, the support parallel positioner being disposed at the support chordwise movable platform, and the support oblique movable platform being provided with a support chordwise driver configured to drive the support chordwise movable platform.

8. The mirror milling machining equipment according to claim 7, wherein the support chordwise driver comprises a support chordwise drive motor and a support chordwise drive lead screw, the support chordwise drive motor being disposed at the support oblique movable platform, the support chordwise drive lead screw being in a transmission connection with the support chordwise drive motor, and the support chordwise drive lead screw being threaded with a nut of the support chordwise movable platform.

9. The mirror milling machining equipment according to claim 8, wherein the support member is rotatably mounted at the support parallel positioner through a support member hinge.

10. A control method for the mirror milling machining equipment for large-scale rotary spherical thin-walled parts according to claim 1, the control method comprising the following steps:
S1, mounting the to-be-machined part at the annular rotary table;
S2, driving, by the machining positioning assembly, the machining device to position the machining device at a to-be-machined surface of the to-be-machined part;
S3, driving, by the support positioning assembly, the support member to position the support member at a position coincident with an axis of the machining device;
S4, driving, by the annular rotary table, the to-be-machined part to rotate, for completing machining of one parallel of the to-be-machined part;
S5, driving, by the machining positioning assembly, the machining device and driving, by the support positioning assembly, the support member, to move the machining device and the support member to a next parallel of the to-be-machined part; and
S6, repeating step S4 and step S5, until machining of a surface of the to-be-machined part is completed.

11. The control method according to claim 10, wherein:
the machining positioning assembly further comprises a machining radial driver configured to drive the machining radial movable platform, a machining pivotal driver configured to drive the machining pivotal movable platform, and a machining oblique driver configured to drive the machining oblique movable platform;
the support positioning assembly further comprises a support oblique driver configured to drive the support oblique movable platform; and
the annular base is provided with a rotary table driver configured to drive the annular rotary table.

12. The control method according to claim 11, wherein:
the machining radial driver comprises a machining radial drive lead screw and a machining radial drive motor, the machining radial drive motor being mounted at the machining base, and the machining radial drive lead screw being in a transmission connection with the machining radial drive motor and being threaded with a nut of the machining radial movable platform;
the machining pivotal driver comprises a pivotal drive lead screw, a pivotal drive motor, and a pivotal drive nut, the pivotal drive motor being pivotally mounted at the machining radial movable platform and being in a transmission connection with the pivotal drive lead screw, the pivotal drive lead screw being threaded with the pivotal drive nut, and the pivotal drive nut being pivotally mounted at the machining pivotal movable platform;
the machining oblique driver comprises a machining oblique drive lead screw and a machining oblique drive motor, the machining oblique drive motor being mounted at the machining radial movable platform, and the machining oblique drive lead screw being in a transmission connection with the machining oblique drive motor and being threaded with a nut of the machining oblique movable platform;
the support oblique driver comprises a support oblique drive lead screw and a support oblique drive motor, the support oblique drive motor being mounted at the support base, and the support oblique drive lead screw being in a transmission connection with the support oblique drive motor and being threaded with a nut of the support oblique movable platform; and
the rotary table driver comprises a rotary table motor, a gear, and a gear ring, the gear ring being disposed at the annular base, the rotary table motor being disposed at the annular rotary table, and the gear being in a transmission connection with a motor shaft of the rotary table motor and being engaged with the gear ring.

13. The control method according to claim 10, wherein:
the machining parallel positioner comprises a machining parallel positioning support and a plurality of machining side chains, each of the plurality of machining side chains being connected to the machining parallel positioning support and the machining device, and the machining parallel positioning support being connected to the machining oblique movable platform; and
the support parallel positioner comprises a supporting parallel positioning support and a plurality of support side chains, each of the plurality of support side chains being connected to the supporting parallel positioning support and the support member, and the supporting parallel positioning support being connected to the support oblique movable platform.

14. The control method according to claim 13, wherein:
the machining side chain comprises a machining hollow motor and a machining ball lead screw, the machining hollow motor being in a transmission connection with the machining ball lead screw, the machining ball lead screw being driven through a rotation of the machining hollow motor to rotate along a central axis and move in an axial direction, the machining hollow motor being connected to the machining parallel positioning support through a first machining hinge, the machining ball lead screw being connected to the machining device through a second machining hinge, five machining side chains being provided, five second machining hinges being provided, four of the five second machining hinges each being a double-revolute-joint hinge, one of the five second machining hinges being a single-revolute-joint hinge, and five first machining hinges being provided and each being a double-revolute-joint hinge; or
the machining side chain comprises a machining side chain track, a machining side chain slider, a machining side chain connection rod, and a machining slider motor, the machining side chain track being connected to the machining parallel positioning support, the machining side chain slider being slidably disposed at the machining side chain track, the machining slider motor being in a transmission connection with the machining side chain slider, and the machining side chain connection rod having an end connected to the machining side chain slider through the first machining hinge and another end connected to the machining device through the second machining hinge; or
the machining side chain comprises a machining electric cylinder, a machining retractable rod, and a machining retractable motor, the machining retractable rod being movably disposed in the machining electric cylinder in an axial direction, the machining retractable motor being disposed at the machining electric cylinder and being in a transmission connection with the machining retractable rod, the machining electric cylinder being connected to the machining parallel positioning support through the first machining hinge, the machining retractable rod being connected to the machining device through the second machining hinge, four machining side chains being provided, the second machining hinge being a spherical hinge, four first machining hinges being provided, two of the four first machining hinges being single-revolute-joint hinges having parallel rotation axes, and the remaining two of the four first machining hinges being double-revolute-joint hinges; or
the machining side chain comprises a machining electric cylinder, a machining retractable rod, and a machining retractable motor, the machining retractable rod being movably disposed in the machining electric cylinder in an axial direction, the machining retractable motor being disposed at the machining electric cylinder and being in a transmission connection with the machining retractable rod, the machining electric cylinder being connected to the machining parallel positioning support through the first machining hinge, the machining retractable rod being connected to the machining device through the second machining hinge, four machining side chains being provided, the second machining hinge being a spherical hinge, four first machining hinges being provided, two of the four first machining hinges being single-revolute-joint hinges having parallel rotation axes, the remaining two of the four first machining hinges being double-revolute-joint hinges, a passive retractable side chain being connected between the machining device and the machining parallel positioning support, the passive retractable side chain comprising an outer sleeve and a passive retractable rod, the passive retractable rod being movably engaged in the outer sleeve in an axial direction and connected to the machining device through a first passive hinge, the outer sleeve being connected to the machining parallel positioning support through a second passive hinge, the first passive hinge being a double-revolute-joint hinge, and the second passive hinge being a single-revolute-joint hinge.

15. The control method according to claim 13, wherein:
the support side chain comprises a support hollow motor and a support ball lead screw, the support hollow motor being in a transmission connection with the support ball lead screw, the support ball lead screw being driven through a rotation of the support hollow motor to rotate along a central axis and move in an axial direction, the support hollow motor being connected to the supporting parallel positioning support through a first support hinge, the support ball lead screw being connected to the support member through a second support hinge, three support side chains being provided, the first support hinge being a single-revolute-joint hinge, the second support hinge being a double-revolute-joint hinge, and the support member being provided with a plurality of support protrusions; or
the support side chain comprises a support side chain track, a support side chain slider, a support side chain connection rod, and a support slider motor, the support side chain track being connected to the supporting parallel positioning support, the support side chain slider being slidably disposed at the support side chain track, the support slider motor being in a transmission connection with the support side chain slider, the support side chain connection rod having an end connected to the support side chain slider through the first support hinge and another end connected to the support member through the second support hinge, three support side chains being provided, three first support hinges being provided and each being a single-revolute-joint hinge, three second support hinges being provided and each being a spherical hinge, and the support member being provided with a plurality of support protrusions; or
the support side chain comprises a support electric cylinder, a support retractable rod, and a support retractable motor, the support retractable rod being movably disposed in the support electric cylinder in an axial direction, the support retractable motor being disposed at the support electric cylinder and in a transmission connection with the support retractable rod, the support electric cylinder being connected to the supporting parallel positioning support through the first support hinge, the support retractable rod being connected to the support member through the second support hinge, three support side chains being provided, each of the first support hinge and the second support hinge being a double-revolute-joint hinge, a plane where rotation axes of two revolute joints of the first support hinge are located being parallel to a plane where rotation axes of two revolute joints of the second support hinge are located, the support member being a ball-joint support member or comprising a support member base and a support member body provided with a plurality of support protrusions, and the support member body being connected to the support member base through a spherical hinge or a double-revolute-joint hinge.

16. The control method according to claim 10, wherein the support oblique movable platform is provided with a support chordwise track extending in a chordwise direction of the annular rotary table, the support chordwise track being provided with a support chordwise movable platform slidably engaged with the support chordwise track, the support parallel positioner being disposed at the support chordwise movable platform, and the support oblique movable platform being provided with a support chordwise driver configured to drive the support chordwise movable platform.

17. The control method according to claim 16, wherein the support chordwise driver comprises a support chordwise drive motor and a support chordwise drive lead screw, the support chordwise drive motor being disposed at the support oblique movable platform, the support chordwise drive lead screw being in a transmission connection with the support chordwise drive motor, and the support chordwise drive lead screw being threaded with a nut of the support chordwise movable platform.

18. The control method according to claim 17, wherein the support member is rotatably mounted at the support parallel positioner through a support member hinge.
